(19) United States
(12) Patent Application Publication
(10) Pub. No.: US 2020/0193435 A1
(43) Pub. Date: Jun. 18, 2020

(54) SYSTEMS AND METHODS FOR IDENTIFYING AND PROCESSING OF PERSON-TO-PERSON PAYMENTS

(71) Applicant: JPMORGAN CHASE BANK, N.A., New York, NY (US)

(72) Inventors: Howard SPECTOR, Woolwich, NJ (US); Tuan DAO, Richardson, TX (US); Scott H. OUELLETTE, Kingston, NH (US); Sunil MATHUR, Hockessin, DE (US)

(21) Appl. No.: 16/707,852

(22) Filed: Dec. 9, 2019

Related U.S. Application Data
(60) Provisional application No. 62/778,977, filed on Dec. 13, 2018.

(51) Int. Cl. G06Q 20/40; G06Q 20/10; G06Q 20/04; G06Q 20/38; G06Q 20/12; G06Q 20/22

(52) U.S. Cl. CPC G06Q 20/405; G06Q 20/10; G06Q 20/04; G06Q 20/3821; G06Q 20/401; G06Q 20/403; G06Q 20/223; G06Q 20/407; G06Q 20/12

(57) ABSTRACT

Systems and methods for identifying and processing person-to-person payments are disclosed. In one embodiment, in an information processing apparatus comprising at least one computer processor, a method for processing a transaction may include: (1) receiving, from a third-party payment platform and via a card association and an acquirer, a transaction request comprising a person-to-person payment indicator in a pass-through field in the transaction request; (2) updating a token transaction characteristic value to contain a person-to-person payment flag; and (3) applying a business rule to the transaction request based on the person-to-person payment flag.

### RELATED APPLICATIONS

This application claims the benefit of, and priority to, U.S. Provisional Patent Application Ser. No. 62/778,977, filed Dec. 13, 2018, the disclosure of which is hereby incorporated, by reference, in its entirety.

### BACKGROUND OF THE INVENTION

### 1. Field of the Invention

The present disclosure generally relates to systems and methods for identifying and processing person-to-person payments.

### 2. Description of Related Art

Third party payment platforms can facilitate both person-to-business (“P2B”) payments, such as a person paying a merchant for goods or services, as well as a person making paying another person (i.e., a person-to-person, or “P2P”) payment. When a financial institution receives a purchase transaction from a third-party payment platform, however, it must determine whether it treat it as a P2P payment or as a P2B payment because different processing rules may be applied to P2P transactions.

### SUMMARY OF THE INVENTION

Systems and methods for identifying and processing person-to-person payments are disclosed. In one embodiment, in an information processing apparatus comprising at least one computer processor, a method for processing a transaction may include: (1) receiving, from a third-party payment platform and via a card association and an acquirer, a transaction request comprising a person-to-person payment indicator in a pass-through field in the transaction request; (2) updating a token transaction characteristic value to contain a person-to-person payment flag; and (3) applying a business rule to the transaction request based on the person-to-person payment flag.

In one embodiment, the pass-through field may be a transaction description field, a VT field, etc.

In one embodiment, the business transaction rule may include a transaction authorization rule, a cash advance limit, a charge-back rule, a settlement rule, etc.

In one embodiment, the card association and the acquirer do not alter the indicator in the pass-through field.

According to another embodiment, a system for processing a transaction may include a third-party payment platform, an acquirer, a card network, and an issuer. The acquirer may receive, from the third-party payment platform, a transaction request comprising a person-to-person payment indicator in a pass-through field in the transaction request. The card network may receive, from the acquirer, the transaction request with the person-to-person payment indicator in the pass-through field in the transaction request. The issuer may receive, from the card network, the transaction request with the person-to-person payment indicator in the pass-through field in the transaction request, may update a token transaction characteristic value to contain a person-to-person payment flag, and may apply a business rule to the transaction request based on the person-to-person payment flag.

In one embodiment, the pass-through field may be a transaction description field, a VT field, etc.

In one embodiment, the business transaction rule may include a transaction authorization rule, a cash advance limit, a charge-back rule, a settlement rule, etc.

In one embodiment, the card association and the acquirer do not alter the indicator in the pass-through field.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for identifying and processing person-to-person payments according to one embodiment; and

FIG. 2 depicts a method for identifying and processing person-to-person payments according to one embodiment.

### DETAILED DESCRIPTION OF PREFERRED EMBODIMENTS

Systems and methods for identifying and processing person-to-person payments are disclosed.

Although this disclosure may be in the context of communicating a P2P payment indicator from the acquirer to the issuer using a pass-through field for the transaction, it should be recognized that this this disclosure is not so limited. The generic pass-through field is a generic multi-use transport vehicle, capable of supporting multiple unrelated pieces of data. For example, indicators may be sent instead of, or in addition to, the P2P indicator, such as a merchant ID used for intercompany billing, a promo code for an offers platform, a co-brand indicator for a co-brand platform, etc. Any other suitable indicator that may be useful to the issuer may be provided in the pass-through field as is necessary and/or desired.

In embodiments, a method for identifying and processing person-to-person payments is disclosed according to one embodiment. For example, a third-party P2P payment provider or wallet, such as PayPal, Venmo, Facebook, etc. may present a P2P transaction request to an acquirer. In one embodiment, the transaction may be a tokenized transaction, or a non-tokenized transaction. Other methods of mapping an identifier to an account may be used as is necessary and/or desired.

In one embodiment, the transaction request may include a unique indicator that indicates that it is a P2P transaction. The indicator may be provided in any suitable field including, for example, pass-through transaction description field 104, the VT field, etc. Any other suitable field may be used as is necessary and/or desired.

In another embodiment, the indicator may be delivered to the issuing platform outside of the transaction processing stream, and matched to the transaction at a later time.

In another embodiment, instead of an indicator, the customer's intent may be derived from the context of the interaction between the P2P provider and the issuer.

In embodiments, the P2P indicator may be used to distinguish P2P transactions from non-P2P transactions such that:

1. Debit authorizations rules, credit authorizations rules, and credit account treatment strategies may be stratified based on payment type (P2P versus non-P2P);

2. Cash advance limits and other fraud rules that manage the credit risk associated with cash advances may incorporate P2P transactions as needed to manage the risk;

3. Contractual terms with the third-party P2P payment provider that allow the issuer to charge back P2P transactions confirmed to be fraudulent must be enforced regardless of the cause of fraud;

4. Authorizations and Settlement records written to the data warehouse today may be augmented to include an indicator that distinguishes P2P payments from other payments, for the use in analytics to monitor volumes and identify fraud trends; and

5. Servicing applications that display transaction level information may identify P2P payments as cash/cash equivalent transactions, consistent with other cash advance credit transactions.

In one embodiment, feedback may be provided to the P2P provider in the form of, for example, a confidence score, in order to extend and enhance fraud checking by pushing the fraud checks up stream where the P2P provider has more context to apply the rules.

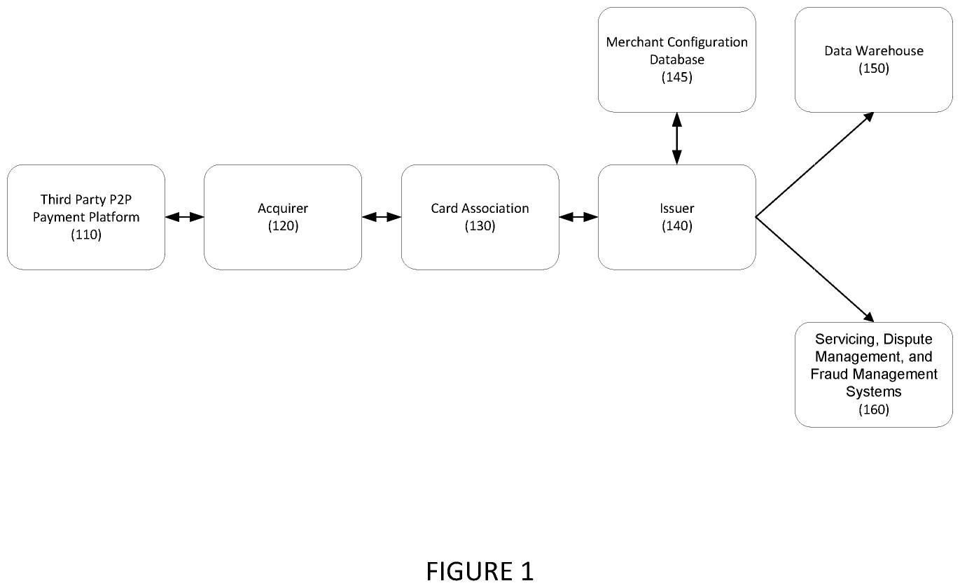

Referring to FIG. 1, a system for identifying and processing person-to-person payments is provided according to one embodiment. System 100 may include third party P2P payment platform 110, merchant's acquirer 120, card association 130, issuer 140, and data warehouse 150.

Third party P2P payment platform 110 may provide individuals with the ability to make P2P payments using a credit card to fund the transactions. In one embodiment, third party P2P payment platform 110 may use a website, an application, etc. to facilitate payments. Examples of third party P2P payment platform 110 include PayPal and Venmo.

Third party P2P payment platform 110 may receive a transaction request from a customer (not shown) with a P2P indictor. For example, the transaction may be a P2P payment that uses a credit card to fund the transaction.

Acquirer 120 may acquire a transaction request from third party P2P payment platform 110, and may pass the transaction request to card association 130.

In one embodiment, acquirer 120 may pass the transaction request 130 to card association 130 without editing the field that contains the P2P payment indicator. In one embodiment, the field or fields with the P2P payment indicator should not be changed by acquirer 120.

Card association 130 may communicate the transaction request from acquirer 120 to issuer 140. In one embodiment, card association 130 may pass the transaction request 130 to issuer 140 without editing or changing the field that contains the P2P payment indicator. In one embodiment, the field or fields with the P2P payment indicator should not be changed by card association 130.

Issuer 140 may receive the transaction request from card association 130, and may identify the transaction as a P2P transaction based on the P2P indicator, and may update the token transaction characteristic (TTC) value to contain a P2P payment flag. Issuer 140 may apply business rules that may drive any changes to the processing, fraud analysis, and/or approvals as is necessary and/or desired.

Issuer 140 may further apply rules and policies from merchant configuration database 145 to the transaction based on the presence of the P2P payment flag. Merchant configuration database 145 may include information for merchants, third party payment platforms, etc., including any fraud liability policy (e.g., zero-fraud liability, or ZFL).

In one embodiment, issuer 140 may assign a value to the transaction and may handle any financial items, such as change to interest rate or interchange. Other systems, such as servicing, dispute management, fraud management systems 160 may apply their own rules on how to treat the transaction.

Data warehouse 150 may store the P2P indicator and other transaction details, and may be the source for servicing tools, dispute actions, statementing, online tools, etc. Servicing, dispute management, and fraud management systems 160 may apply the business rules.

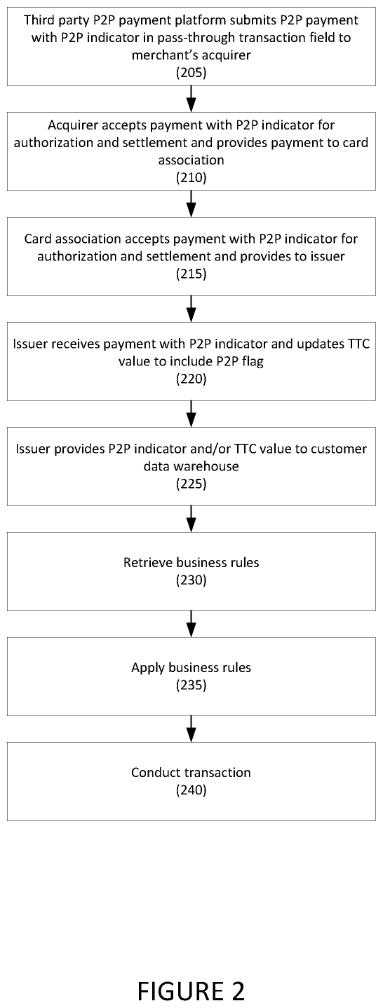

Referring to FIG. 2, a method for identifying and processing person-to-person payments is provided according to one embodiment.

In step 205, a third party P2P payment platform may submit a P2P payment with a P2P indicator to an acquirer for a transaction request. The transaction may be a tokenized transaction, a non-tokenized transaction (e.g., FPAN), etc.

In step 210, the acquirer may accept the P2P indicator for both authorization and settlement, and may pass it to a credit card association (e.g., Visa) in, for example, pass-through field 104, VT field, etc. The acquirer should not edit or change the field in which the P2P indicator is present.

In step 215, the credit card association may accept the P2P indicator acquirer for both authorization and settlement, and may pass it to the issuer. In one embodiment, the P2P indicator may be passed using pass-through field 104. The credit card association should not edit or change the field in which the P2P indicator is present.

In step 220, the issuer may receive the field with the P2P indicator and may update the token transaction characteristic (TTC) value to contain a P2P payment flag. This may be used to drive any changes to the processing, fraud analysis, and/or approvals in, for example, downstream systems.

In step 225, the issuer may provide the P2P indicator (e.g., in pass-through field 104, the VT field, etc.), the TTC, or both, to the customer data warehouse. The data warehouse may store the P2P indicator and other transaction details. In one embodiment, the data warehouse may be the source for servicing tools, dispute actions, statementing, online tools, etc. Thus, once the P2P indicator is in the data warehouse, it may be used by other processes and applications.

In step 230, the issuing platform may retrieve one or business rule or policy from, for example, a merchant configuration database, a rules database, etc. In one embodiment, the rules may be, for example, pricing rules, fraud liability rules, other reporting rules, etc. For example, P2P payments may have different charges that P2B payments, may not be eligible for zero-fraud liability (ZFL), may be reported differently, etc.

In step 235, the issuing platform may apply the business rule or policy to the P2P transaction, and, in step 240, the transaction may be conducted.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for processing a transaction, comprising:
in an information processing apparatus comprising at least one computer processor:
receiving, from a third-party payment platform and via a card association and an acquirer, a transaction request comprising a person-to-person payment indicator in a pass-through field in the transaction request;
updating a token transaction characteristic value to contain a person-to-person payment flag; and
applying a business rule to the transaction request based on the person-to-person payment flag.

2. The method of claim 1, wherein the pass-through field that comprises the person-to-person indicator is a transaction description field.

3. The method of claim 1, wherein the pass-through field that comprises the person-to-person indicator is a VT field.

4. The method of claim 1, wherein the business transaction rule comprises a transaction authorization rule.

5. The method of claim 1, wherein the business transaction rule comprises a cash advance limit.

6. The method of claim 1, wherein the business transaction rule comprises a charge-back rule.

7. The method of claim 1, wherein the business transaction rule comprises a settlement rule.

8. The method of claim 1, wherein the card association and the acquirer do not alter the indicator in the pass-through field.

9. A system for processing a transaction, comprising:
a third-party payment platform;
an acquirer;
a card network; and
an issuer;
wherein:
the acquirer receives, from the third-party payment platform, a transaction request comprising a person-to-person payment indicator in a pass-through field in the transaction request;
the card network receives, from the acquirer, the transaction request with the person-to-person payment indicator in the pass-through field in the transaction request;
the issuer receives, from the card network, the transaction request with the person-to-person payment indicator in the pass-through field in the transaction request;
the issuer updates a token transaction characteristic value to contain a person-to-person payment flag; and
the issuer applies a business rule to the transaction request based on the person-to-person payment flag.

10. The system of claim 9, wherein the pass-through field that comprises the person-to-person indicator is a transaction description field.

11. The system of claim 9, wherein the pass-through field that comprises the person-to-person indicator is a VT field.

12. The system of claim 9, wherein the business transaction rule comprises a transaction authorization rule.

13. The system of claim 9, wherein the business transaction rule comprises a cash advance limit.

14. The system of claim 9, wherein the business transaction rule comprises a charge-back rule.

15. The system of claim 9, wherein the business transaction rule comprises a settlement rule.

16. The system of claim 9, wherein the card association and the acquirer do not alter the indicator in the pass-through field.
